(19) United States
(12) Patent Application Publication
(10) Pub. No.: US 2025/0208455 A1
(43) Pub. Date: Jun. 26, 2025

(54) POLARIZATION MODULATION DEVICE

(71) Applicant: Shanghai AVIC Optoelectronics Co., Ltd., Shanghai (CN)

(72) Inventors: Yukie KEICHO, Kawasaki (JP); Tetsushi SATO, Kawasaki (JP)

(73) Assignee: Shanghai AVIC Optoelectronics Co., Ltd., Shanghai (CN)

(21) Appl. No.: 18/964,813

(22) Filed: Dec. 2, 2024

(30) Foreign Application Priority Data
Dec. 25, 2023 (JP) 2023-217616

(51) Int. Cl. G02F 1/133; G02F 1/1335

(52) U.S. Cl. CPC G02F 1/13306; G02F 1/133528

(57) ABSTRACT

A polarization modulation device includes a polarization modulation element including a plurality of liquid crystal cells, and a controller that applies voltage to each of the plurality of liquid crystal cells. In a case in which an average value of the angle of the alignment axis of the light incident-side substrate and the angle of the alignment axis of the light emitting-side substrate in each of the plurality of liquid crystal cells is defined as an average alignment angle, the controller applies a voltage that is higher than a voltage applied to the other liquid crystal cells to the liquid crystal cell for which the absolute value of the difference between 45° and the average alignment angle is smallest.

### CROSS-REFERENCE TO RELATED APPLICATIONS

This application claims the benefit of Japanese Patent Application No. 2023-217616, filed on Dec. 25, 2023, the entire disclosure of which is incorporated by reference herein.

### FIELD OF THE INVENTION

The present disclosure relates generally to a polarization modulation device.

### BACKGROUND OF THE INVENTION

Polarization modulation elements that include a plurality of liquid crystal cells are known in the related art. For example, Unexamined Japanese Patent Application Publication No. 2003-98503 describes a liquid crystal optical switch (polarization modulation element) including a liquid crystal polarization rotator formed from a plurality of liquid crystal cells with anti-parallel or parallel alignment.

In the plurality of liquid crystal cells of Unexamined Japanese Patent Application Publication No. 2003-98503, the ratios between the cell thickness of each liquid crystal cell and the retardation of the liquid crystal layer of each liquid crystal cell are substantially equal. Additionally, in adjacent liquid crystal cells, a light emitting-side substrate and a light incident-side substrate face each other, and the liquid crystal director azimuth angle of the liquid crystal layer in contact with the light emitting-side substrate and the liquid crystal director azimuth angle of the liquid crystal layer in contact with the light incident-side substrate are substantially equal.

In a state in which voltage is not applied to the plurality of liquid crystal cells, the liquid crystal optical switch of Unexamined Japanese Patent Application Publication No. 2003-98503 functions as a half-wave plate for linearly polarized incident light. Meanwhile, in a state in which voltage is applied to the plurality of liquid crystal cells, the liquid crystal optical switch of Unexamined Japanese Patent Application Publication No. 2003-98503 emits without rotating the polarization direction of the linearly polarized incident light, and does not function as a half-wave plate. In Unexamined Japanese Patent Application Publication No. 2003-98503, shortening of the response time of the liquid crystal optical switch is realized by reducing the cell thickness of each of the liquid crystal cells.

In liquid crystal cells with anti-parallel or parallel alignments, the liquid crystal molecules near the interface between the liquid crystal layer and the substrate (alignment film) are less likely to respond to the applied voltage and, consequently, birefringence due to the liquid crystal molecules remains near the interface. Accordingly, when the linearly polarized light enters in the state in which voltage is applied, the emission light from the liquid crystal optical switch of Unexamined Japanese Patent Application Publication No. 2003-98503 becomes elliptically polarized light due to the residual birefringence. As such, with the liquid crystal optical switch of Unexamined Japanese Patent Application Publication No. 2003-98503, the intensity of the polarized light component having the desired polarization direction decreases. Moreover, when high voltage is applied to the liquid crystal cells to cause the liquid crystal molecules near the interface to respond, power consumption increases, and the liquid crystal cells may short.

### SUMMARY OF THE INVENTION

A polarization modulation device according to the present disclosure includes:
a polarization modulation element including a plurality of liquid crystal cells, each of which includes a light incident-side substrate, a light emitting-side substrate opposing the light incident-side substrate, and a liquid crystal layer sandwiched between the light incident-side substrate and the light emitting-side substrate, linearly polarized light entering the light incident-side substrate of a first liquid crystal cell among the plurality of liquid crystal cells; and
a controller that applies voltage to each of the plurality of liquid crystal cells to switch a polarization direction of emission light emitted from the polarization modulation element, wherein
the plurality of liquid crystal cells are sequentially stacked with the light incident-side substrate of one of the liquid crystal cells opposing the light emitting-side substrate of another of the liquid crystal cells, and
in a case in which each of an angle of an alignment axis of the light incident-side substrate and an angle of an alignment axis of the light emitting-side substrate is set to an angle relative to a polarization direction of the linearly polarized light, and an average value of the angle of the alignment axis of the light incident-side substrate and the angle of the alignment axis of the light emitting-side substrate in each of the plurality of liquid crystal cells is defined as an average alignment angle,
   the average alignment angle of each of the plurality of liquid crystal cells differs from each other,
   the plurality of liquid crystal cells includes at least one liquid crystal cell for which an absolute value of a difference between 45° and the average alignment angle differs from the absolute value of another of the liquid crystal cells, and
   the controller applies a voltage that is higher than a voltage applied to the other liquid crystal cells to the liquid crystal cell for which the absolute value is smallest.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a schematic drawing illustrating a polarization modulation device according to Embodiment 1;

FIG. 2 is a schematic drawing illustrating a cross-section of a polarization modulation element according to Embodiment 1;

FIG. 3 is a schematic drawing illustrating a cross-section of a liquid crystal cell according to Embodiment 1;

FIG. 4 is a schematic drawing illustrating an alignment axis and an alignment of a liquid crystal according to Embodiment 1;

FIG. 5 is a schematic drawing illustrating an angle of an alignment axis of a light incident-side substrate according to Embodiment 1;

FIG. 6 is a schematic drawing illustrating an angle of an alignment axis of a light emitting-side substrate according to Embodiment 1;

FIG. 7 is a schematic drawing illustrating an alignment axis and an alignment state of the liquid crystal of the polarization modulation element according to Embodiment 1, in an initial alignment state;

FIG. 8 is a drawing illustrating the alignment axes of the light incident-side substrate and the light emitting-side substrate of a first liquid crystal cell according to Embodiment 1;

FIG. 9 is a drawing illustrating the alignment axes of the light incident-side substrate and the light emitting-side substrate of a second liquid crystal cell according to Embodiment 1;

FIG. 10 is a drawing illustrating the alignment axes of the light incident-side substrate and the light emitting-side substrate of a third liquid crystal cell according to Embodiment 1;

FIG. 11 is a drawing illustrating an example of polarization contrast and voltage to be applied to each of the liquid crystal cells according to Embodiment 1;

FIG. 12 is a drawing illustrating the relationship between the polarization contrast and an average voltage value according to Embodiment 1;

FIG. 13 is a drawing illustrating the relationship between a wavelength of linearly polarized light and the polarization contrast in an ON state, according to Embodiment 1;

FIG. 14 is a drawing illustrating the relationship between the wavelength of the linearly polarized light and the polarization contrast in the initial alignment state, according to Embodiment 1;

FIG. 15 is a schematic drawing illustrating a birefringent plate modeling the first liquid crystal cell according to Embodiment 1;

FIG. 16 is a schematic drawing illustrating a birefringent plate modeling the second liquid crystal cell according to Embodiment 1;

FIG. 17 is a schematic drawing illustrating a birefringent plate modeling the third liquid crystal cell according to Embodiment 1;

FIG. 18 is a schematic drawing illustrating an alignment model according to Embodiment 1;

FIG. 19 is a drawing illustrating the relationship between the voltage to be applied to the liquid crystal cells and residual birefringence in the liquid crystal cells in the ON state, according to Embodiment 1;

FIG. 20 is a drawing illustrating an example of the angles of the alignment axes and the voltage to be applied to the liquid crystal cells according to Embodiment 2;

FIG. 21 is a drawing illustrating the relationship between the wavelength of the linearly polarized light and the polarization contrast in the initial alignment state, according to Embodiment 2;

FIG. 22 is a drawing illustrating the relationship between the wavelength of the linearly polarized light and the polarization contrast in the initial alignment state, according to Embodiment 2;

FIG. 23 is a schematic drawing illustrating a cross-section of a polarization modulation element according to Embodiment 3;

FIG. 24 is a drawing illustrating the alignment axes of the light incident-side substrate and the light emitting-side substrate of a first liquid crystal cell according to Embodiment 3;

FIG. 25 is a drawing illustrating the alignment axes of the light incident-side substrate and the light emitting-side substrate of a second liquid crystal cell according to Embodiment 3;

FIG. 26 is a drawing illustrating the relationship between the wavelength of the linearly polarized light and the polarization contrast in the initial alignment state, according to Embodiment 3;

FIG. 27 is a drawing illustrating an example of the angles of the alignment axes and the voltage to be applied to the liquid crystal cells according to Embodiment 4;

FIG. 28 is a schematic drawing illustrating a cross-section of a polarization modulation element according to Embodiment 5;

FIG. 29 is a drawing illustrating an example of the polarization contrast and the voltage to be applied to each of the liquid crystal cells according to Embodiment 5;

FIG. 30 is a drawing illustrating the relationship between the polarization contrast and an average voltage value according to Embodiment 5;

FIG. 31 is a drawing illustrating the alignment axes of the light incident-side substrate and the light emitting-side substrate of a first liquid crystal cell according to Embodiment 6;

FIG. 32 is a drawing illustrating the alignment axes of the light incident-side substrate and the light emitting-side substrate of a second liquid crystal cell according to Embodiment 6;

FIG. 33 is a drawing illustrating the alignment axes of the light incident-side substrate and the light emitting-side substrate of a third liquid crystal cell according to Embodiment 6;

FIG. 34 is a drawing illustrating the alignment axes of the light incident-side substrate and the light emitting-side substrate of a fourth liquid crystal cell according to Embodiment 6;

FIG. 35 is a drawing illustrating an example of the polarization contrast and the voltage to be applied to each of the liquid crystal cells according to Embodiment 6; and

FIG. 36 is a drawing illustrating the relationship between the polarization contrast and an average voltage value according to Embodiment 6.

### DETAILED DESCRIPTION OF THE INVENTION

Hereinafter, a polarization modulation device according to various embodiments is described while referencing the drawings.

### Embodiment 1

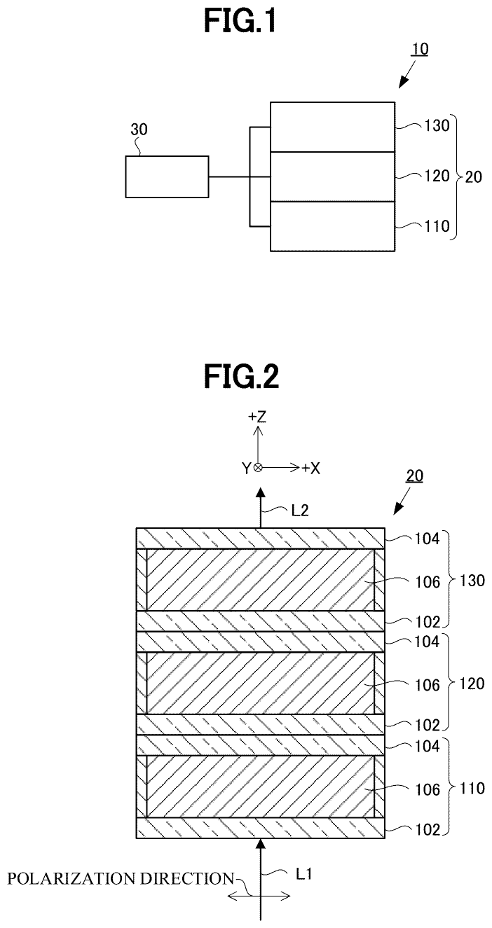

A polarization modulation device 10 according to the present embodiment is described while referencing FIGS. 1 to 19. As illustrated in FIG. 1, the polarization modulation device 10 includes a polarization modulation element 20 and a controller 30. As illustrated in FIGS. 1 and 2, the polarization modulation element 20 includes three liquid crystal cells 110 to 130. The polarization modulation element 20 is formed by sequentially stacking the liquid crystal cells 110 to 130 with non-illustrated adhesive layers provided therebetween. In a state in which voltage is not applied (initial alignment state) to the liquid crystal cells 110 to 130, the polarization modulation element 20 functions as a ½ wavelength plate for linearly polarized light (incident light) L1 incident on the liquid crystal cell 110, and emits emission light L2 in which a phase difference of ½ wavelength is imparted to the linearly polarized light L1. Additionally, in a state in which the voltage is applied to the liquid crystal cells 110 to 130 (ON state), the polarization modulation element 20 maintains the polarization direction of the linearly polarized light L1 and emits the emission light L2. The controller 30 applies the voltage to the liquid crystal cells 110 to 130 to switch the polarization direction of the emission light L2 emitted from the polarization modulation element 20.

In the present specification, to facilitate comprehension, a description is given in which, in FIG. 2, the right direction (the right direction on paper) of the polarization modulation element 20 is referred to as the “+X direction”, the up direction (the up direction on paper) is referred to as the “+Z direction”, and the direction perpendicular to the +X direction and the +Z direction (the depth direction on paper) is referred to as the “+Y direction.” The polarization direction of the linearly polarized light L1 incident on the polarization modulation element 20 is set as the “X direction.” The liquid crystal cells may be referred to as an mth (where m is an integer of 1 or greater) liquid crystal cell from the side on which the linearly polarized light L1 is incident.

The polarization modulation element 20 of the polarization modulation device 10 includes the liquid crystal cells 110 to 130 that are sequentially stacked. In the following, the liquid crystal cells may be referred to collectively as “liquid crystal cells 100.”

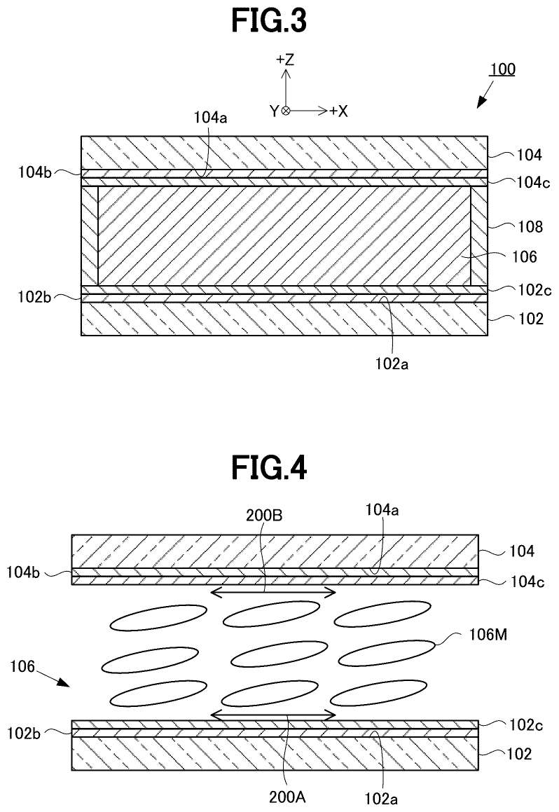

As illustrated in FIG. 3, each of the liquid crystal cells 100 includes a light incident-side substrate 102, a light emitting-side substrate 104, and a nematic liquid crystal 106. As illustrated in FIG. 2, the liquid crystal cells 100 are sequentially stacked with the light incident-side substrate 102 of one of the liquid crystal cells 100 and the light emitting-side substrate 104 of another of the liquid crystal cells 100 opposing each other. In the state in which the voltage is not applied (the initial alignment state), each of the liquid crystal cells 100 of the present embodiment functions as a ½ wavelength plate.

As illustrated in FIG. 2, the light incident-side substrate 102 is a substrate that is positioned on the side on which the linearly polarized light L1 is incident. As illustrated in FIG. 3, the light incident-side substrate 102 opposes the light emitting-side substrate 104. The light incident-side substrate 102 and the light emitting-side substrate 104 sandwich the nematic liquid crystal 106. In one example, the light incident-side substrate 102 is implemented as a glass substrate. The light incident-side substrate 102 includes a light-transmitting electrode 102b and an alignment film 102c on a main surface 102a that opposes the light emitting-side substrate 104.

The light-transmitting electrode 102b of the light incident-side substrate 102 is formed on the entire surface of the main surface 102a. The light-transmitting electrode 102b is formed from indium tin oxide (ITO). The alignment film 102c of the light incident-side substrate 102 aligns the nematic liquid crystal 106 in a predetermined direction. In one example, the alignment film 102c of the light incident-side substrate 102 is implemented as a polyimide alignment film. The alignment of the nematic liquid crystal 106 is described later.

As illustrated in FIG. 2, the light emitting-side substrate 104 is a substrate that is positioned on the side from which the emission light L2 is emitted. As illustrated in FIG. 3, the light incident-side substrate 102 and the light emitting-side substrate 104 are affixed to each other by a seal material 108. In one example, the light emitting-side substrate 104 is implemented as a glass substrate. The light emitting-side substrate 104 includes a light-transmitting electrode 104b and an alignment film 104c on a main surface 104a that opposes the light incident-side substrate 102.

The light-transmitting electrode 104b of the light emitting-side substrate 104 is formed on the entire surface of the main surface 104a. The light-transmitting electrode 104b is formed from indium tin oxide (ITO). The alignment film 104c of the light emitting-side substrate 104 aligns the nematic liquid crystal 106 in a predetermined direction. In one example, the alignment film 104c of the light emitting-side substrate 104 is implemented as a polyimide alignment film.

The nematic liquid crystal 106 is sandwiched by the light incident-side substrate 102 and the light emitting-side substrate 104. In the present embodiment, a refractive index anisotropy Δn of the nematic liquid crystal 106 is 0.1948 at a wavelength of 380 nm, and is 0.1403 at a wavelength of 535 nm. Additionally, a dielectric anisotropy Δs of the nematic liquid crystal 106 is 4.8 at 20° C. A thickness d of the nematic liquid crystal 106 (cell thickness of each of the liquid crystal cells 100) is 1.5 μm. The refractive index anisotropy Δn and the thickness d of the nematic liquid crystal 106 are set to values at which a birefringence Δnd of ½ wavelength is imparted to light having a predetermined wavelength.

Next, the alignment of the nematic liquid crystal 106 (that is, liquid crystal molecules 106M), an angle θ1 of an alignment axis 200A of the light incident-side substrate 102, and an angle θ2 of an alignment axis 200B of the light emitting-side substrate 104 are described. Note that the alignment axes of the light incident-side substrates 102 of the various liquid crystal cells 110 to 130 are referred to collectively as the alignment axis 200A, and the alignment axes of the light emitting-side substrates 104 of the various liquid crystal cells 110 to 130 are referred to collectively as the alignment axis 200B.

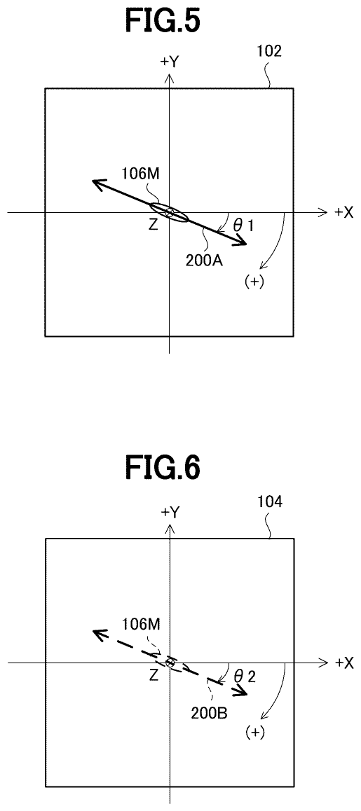

In the present embodiment, as illustrated in FIG. 4, the nematic liquid crystal 106 is anti-parallel aligned by an alignment film 102c of the light incident-side substrate 102 and an alignment film 104c of the light emitting-side substrate 104. In this specification, as illustrated in FIGS. 4 and 5, the alignment axis at an initial alignment of the liquid crystal molecules 106M by the light incident-side substrate 102 (the alignment film 102c) is defined as the alignment axis 200A of the light incident-side substrate 102, and an angle of the alignment axis 200A relative to a polarization direction (X direction) of the linearly polarized light L1 incident on the polarization modulation element 20 is defined as the angle θ1 of the alignment axis 200A of the light incident-side substrate 102. Additionally, as illustrated in FIGS. 4 and 6, the alignment axis at an initial alignment of the liquid crystal molecules 106M by the light emitting-side substrate 104 (the alignment film 104c) is defined as the alignment axis 200B of the light emitting-side substrate 104, and an angle of the alignment axis 200B relative to the polarization direction (X direction) of the linearly polarized light L1 incident on the polarization modulation element 20 is defined as the angle θ2 of the alignment axis 200B of the light emitting-side substrate 104. Furthermore, an average value, in one liquid crystal cell 100, of the angle θ1 of the alignment axis 200A of the light incident-side substrate 102 and the angle θ2 of the alignment axis 200B of the light emitting-side substrate 104 is defined as an average alignment angle θa of the liquid crystal cells 100. In this specification, for the sake of convenience, a description is given in which the +X direction is 0°, and a direction clockwise from the +X direction is defined as the + (plus) direction.

In the present embodiment, the nematic liquid crystal 106 is anti-parallel aligned in the initial alignment state. Accordingly, in one of the liquid crystal cells 100, the angle θ1 of the alignment axis 200A of the light incident-side substrate 102, the angle θ2 of the alignment axis 200B of the light emitting-side substrate 104, and the average alignment angle θa are equal.

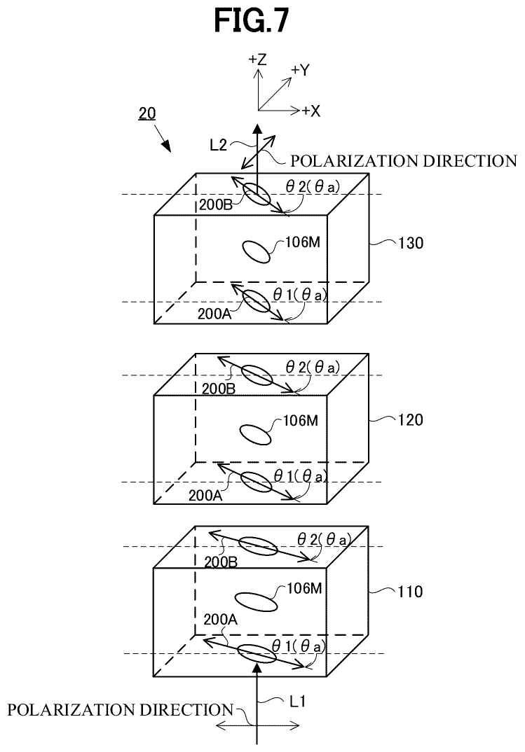

In the liquid crystal cells 110 to 130, as illustrated in FIGS. 7 to 10, the average alignment angles θa (the angle θ1 of the alignment axis 200A and the angle θ2 of the alignment axis 200B) differ from each other. Note that the light incident-side substrate 102, the light emitting-side substrate 104, and the like are omitted from FIG. 7.

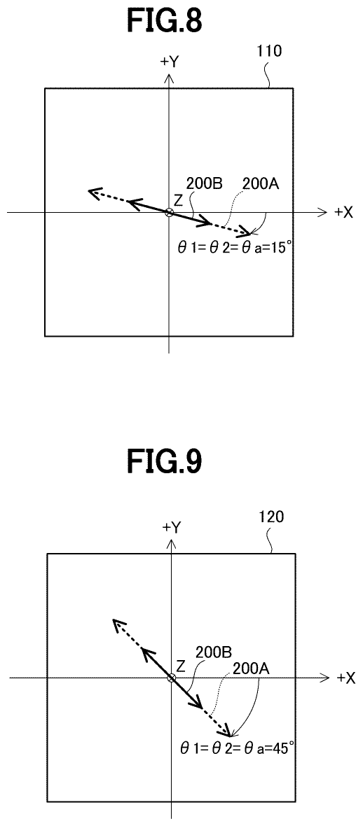

Specifically, in the first liquid crystal cell 110 on which the linearly polarized light L1 is incident, as illustrated in FIG. 8, the angle θ1 of the alignment axis 200A of the light incident-side substrate 102, the angle θ2 of the alignment axis 200B of the light emitting-side substrate 104, and the average alignment angle θa of the liquid crystal cell 110 are 15°. In the second liquid crystal cell 120, as illustrated in FIG. 9, the angle θ1 of the alignment axis 200A of the light incident-side substrate 102, the angle θ2 of the alignment axis 200B of the light emitting-side substrate 104, and the average alignment angle θa of the liquid crystal cell 120 are 45°. Furthermore, in the third liquid crystal cell 130, as illustrated in FIG. 10, the angle θ1 of the alignment axis 200A of the light incident-side substrate 102, the angle θ2 of the alignment axis 200B of the light emitting-side substrate 104, and the average alignment angle θa of the liquid crystal cell 130 are 75°. In the present embodiment, each of the liquid crystal cells 100 functions as a ½ wavelength plate in the initial alignment state and, as such, in a case in which the linearly polarized light L1 that has the polarization direction in the X direction is incident on the polarization modulation element 20 in the initial alignment state, emission light L2 that has the polarization direction in the Y direction is emitted from the polarization modulation element 20.

The controller 30 of the polarization modulation device 10 applies voltage to the liquid crystal cells 110 to 130 to switch the polarization direction of the emission light L2 emitted from the polarization modulation element 20. When switching the polarization direction of the emission light L2 from the Y direction to the X direction, the controller 30 applies a voltage that is higher than the voltage applied to the other liquid crystal cells 100 to the liquid crystal cell 100 for which the absolute value of the difference between 45° and the average alignment angle θa is smallest. The influence, on the emission light L2, of the residual birefringence of the nematic liquid crystal 106 near the interface is greater in the liquid crystal cells 100 for which the average alignment angle θa is close to 45°. Accordingly, by applying voltage that is higher than the voltage applied to the other liquid crystal cells 100 to the liquid crystal cell 100 for which the absolute value of the difference between 45° and the average alignment angle θa is smallest, the influence, on the emission light L2, of the residual birefringence of the nematic liquid crystal 106 near the interface can be reduced, and the voltage applied to the entire polarization modulation element 20 can be reduced.

In the present embodiment, the controller 30 applies a higher voltage than the voltage applied to the liquid crystal cell 110 and the liquid crystal cell 130 to the liquid crystal cell 120 for which the difference between 45° and the average alignment angle θa is zero. Details about the voltages that the controller 30 applies to each of the liquid crystal cells 110 to 130 are described later.

Next, the operations and effects of the polarization modulation device 10 are described. Firstly, polarization contrast pCR is defined. The term “polarization contrast pCR” refers to a ratio of a transmitted light intensity 12 in a case in which the emission light L2 is caused to transmit through an analyzer having a transmission axis parallel to the desired polarization direction of the polarized light component, to a transmitted light intensity I1 in a case in which the emission light L2 is caused to transmit through an analyzer having a transmission axis perpendicular to the desired polarization direction of the polarized light component. The polarization contrast pCR is expressed as pCR=12/11. Higher polarization contrasts pCR indicate higher intensities of the polarized light component. In the present embodiment, in the initial alignment state, the polarization modulation element 20 functions as a ½ wavelength plate for the linearly polarized light L1 and, as such, the desired polarization direction in the initial alignment state is the Y direction. Additionally, in the ON state, the polarization modulation element 20 maintains the polarization direction of the linearly polarized light L1 and emits the light as the emission light L2 and, as such, the desired polarization direction in the ON state is the X direction.

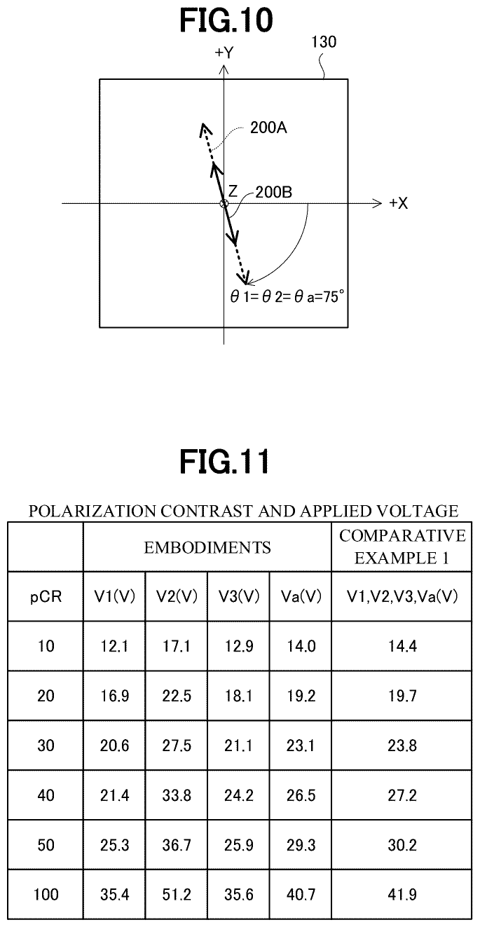

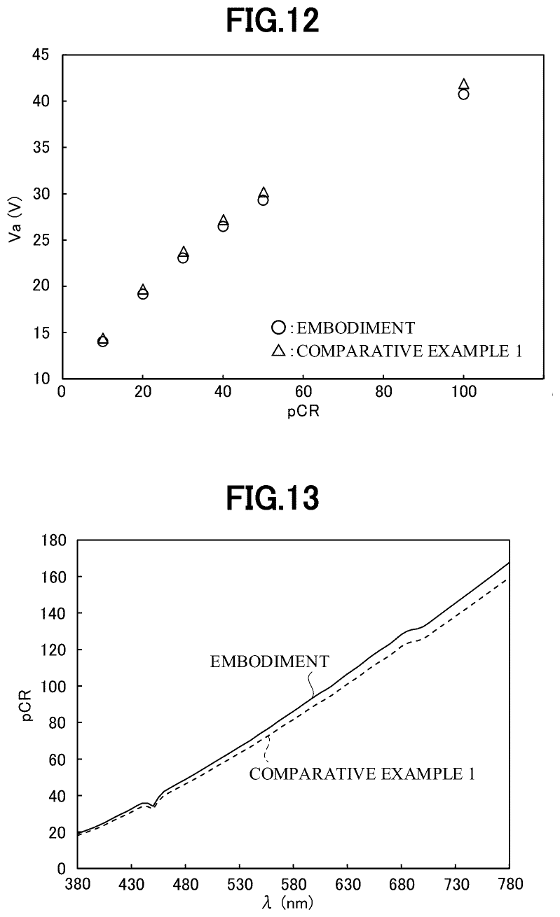

Next, the operations and effects of the polarization modulation device 10 in the ON state are described. FIG. 11 illustrates an example of the polarization contrast pCR and voltages V1 to V3 applied respectively to the liquid crystal cells 110 to 130 in a case in which the voltage V2 that is higher than the voltages V1 and V3 applied to the liquid crystal cell 110 and the liquid crystal cell 130 is applied to the liquid crystal cell 120 for which the absolute value of the difference between 45° and the average alignment angle θa is the smallest; and the polarization contrast pCR and the voltages applied in Comparative Example 1. FIG. 12 illustrates the relationship between the polarization contrast pCR, an average value of the voltages V1 to V3 illustrated in FIG. 11 (hereinafter referred to as “average voltage value Va”), and the average voltage value Va of Comparative Example 1. FIG. 13 illustrates the polarization contrast pCR and a wavelength 2 of the linearly polarized light L1 of the present embodiment (V1=16.9V, V2=22.5V, V3=18.1V) and Comparative Example 1 (V1=V2=V3=19.2V) in a case in which an average voltage value Va of 19.2V is applied.

Comparative Example 1 is an example in which identical voltages are applied to each of the liquid crystal cells 110 to 130 (that is, in Comparative Example 1, the average voltage value Va and the voltages V1 to V3 respectively applied to the liquid crystal cells 110 to 130 are equal). Note that the wavelength 2 of the linearly polarized light L1 in FIGS. 11 and 12 is 380 nm, and the voltages V1 to V3 applied to the liquid crystal cells 110 to 130 and the polarization contrast pCR are obtained by simulation.

As illustrated in FIG. 12, when comparing for the same polarization contrast pCR, the average voltage value Va of the present embodiment is less than the average voltage value Va of Comparative Example 1 (for example, when the polarization contrast pCR is 20, the average voltage value Va of the present embodiment is 19.2V and the average voltage value Va of Comparative Example 1 is 19.7V). That is, the polarization modulation device 10 of the present embodiment can emit, at high intensity and with lower voltage, a polarized light component having a desired polarization direction.

As illustrated in FIG. 13, the polarization contrast pCR of the present embodiment is higher than the polarization contrast pCR of Comparative Example 1 at all wavelengths 2. That is, in the ON state, the polarization modulation device 10 of the present embodiment can emit a polarized light component having a desired polarization direction at high intensity across a wide range of wavelengths.

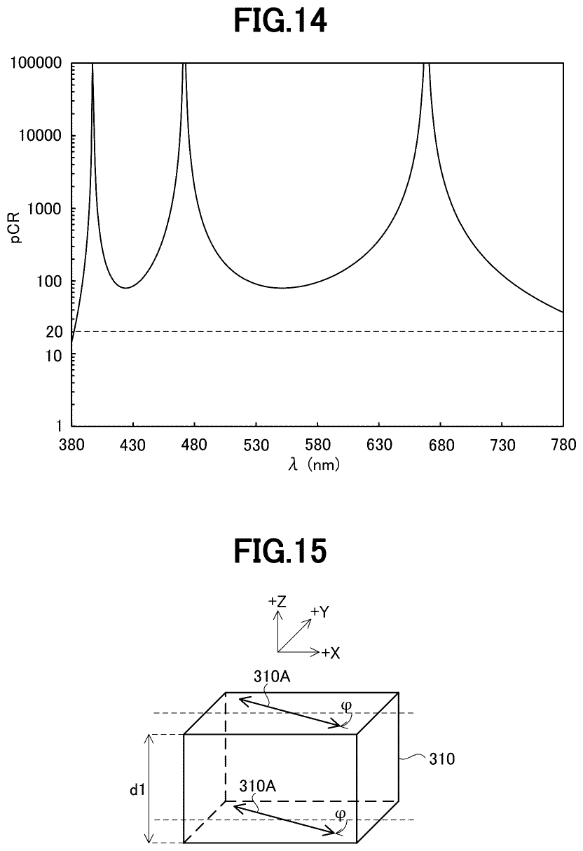

Next, the operations and effects of the polarization modulation device 10 in the initial alignment state are described. FIG. 14 illustrates the polarization contrast pCR and the wavelength 2 of the linearly polarized light L1 of the polarization modulation device 10 (the polarization modulation element 20) in the initial alignment state. As illustrated in FIG. 14, in the initial alignment state, the polarization modulation device 10 can emit a polarized light component having a desired polarization direction at high intensity across a wide range of wavelengths. For example, with the polarization modulation device 10 the polarization contrast pCR is 20 or greater in 99.5% (382 nm to 780 nm) of the wavelengths λ in the range of 380 nm to 780 nm.

Next, the voltages V1 to V3 that the controller 30 respectively applies to the liquid crystal cells 110 to 130 are described. In one example, the voltages V1 to V3 that are respectively applied to the liquid crystal cells 110 to 130 are obtained as follows.

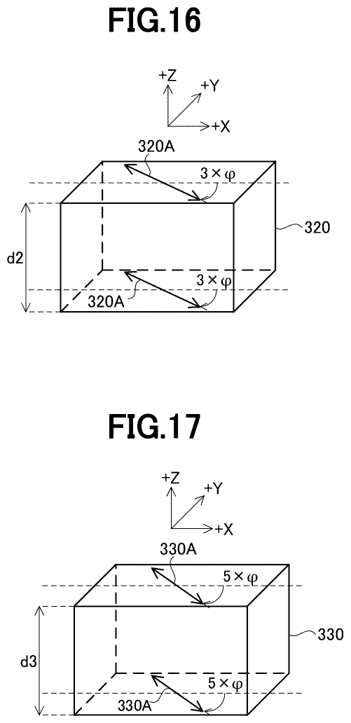

Firstly, each of the liquid crystal cells 110 to 130 is modeled as one birefringent plate. Specifically, as illustrated in FIG. 15, the liquid crystal cell 110 to which the voltage is applied is modeled as a birefringent plate 310 that has an optical axis 310A. In this case, an angle of the optical axis 310A relative to the polarization direction (the X direction) of the linearly polarized light L1 is defined as q. The angle q of the optical axis 310A is 15°, the same as the angles θ1 and 02 of the alignment axes 200A, 200B of the liquid crystal cell 110. Additionally, as illustrated in FIG. 16, the liquid crystal cell 120 to which the voltage is applied is modeled as a birefringent plate 320 that has an optical axis 320A. Furthermore, as illustrated in FIG. 17, the liquid crystal cell 130 to which the voltage is applied is modeled as a birefringent plate 330 that has an optical axis 330A. The angle of the optical axis 320A relative to the polarization direction of the linearly polarized light L1 corresponds to 3×0, and the angle of the optical axis 330A relative to the polarization direction of the linearly polarized light L1 corresponds to 5×φ.

Here, the voltage V1 is applied to the liquid crystal cell 110, the voltage V2 is applied to the liquid crystal cell 120, the voltage V3 is applied to the liquid crystal cell 130, a thickness of the birefringent plate 310 is defined as d1, a thickness of the birefringent plate 320 is defined as d2, a thickness of the birefringent plate 330 is defined as d3, and a refractive index anisotropy of the birefringent plates 310 to 330 is defined as Δn.

A Jones matrix of the birefringent plates is expressed by the following Equation (1) and, when viewed from above from the +Z side, the Jones matrix of the birefringent plates, in which the optical axis is inclined the angle φ with respect to the linearly polarized light L1 that has the polarization direction in the X direction, is expressed by the following Equation (2). As such, the Jones matrix of each of the birefringent plates 310 to 330 is expressed by the following Equations (3) to (5).

$$W ( Γ ) = [ \begin{matrix}{e}^{- i Γ / 2} & 0 \\ 0 & {e}^{i Γ / 2}\end{matrix} ] \qquad ( 1 )$$

$$W = [ \begin{matrix}cos ϕ & - sin ϕ \\ sin ϕ & cos ϕ\end{matrix} ] [ \begin{matrix}{e}^{- i Γ / 2} & 0 \\ 0 & {e}^{i Γ / 2}\end{matrix} ] [ \begin{matrix}cos ϕ & sin ϕ \\ - sin ϕ & cos ϕ\end{matrix} ] = R ( - ϕ ) W ( Γ ) R ( ϕ ) \qquad ( 2 )$$

$$W = R ( - ϕ ) W ( Γ1 ) R ( ϕ ) \qquad ( 3 )$$

$$W = R ( - 3 ϕ ) W ( Γ2 ) R ( 3 ϕ ) \qquad ( 4 )$$

$$W = R ( - 5 ϕ ) W ( Γ3 ) R ( 5 ϕ ) \qquad ( 5 )$$

The overall Jones matrix of the birefringent plates 310 to 330 (that is, the Jones matrix corresponding to the entire polarization modulation element 20) is expressed by the following Equation (6). Here, Γ1, Γ2, and Γ3 are expressed by the following Equations (7) to (9). 2 is the wavelength of the linearly polarized light L1.

$$W = R ( - 5 ϕ ) W ( Γ3 ) R ( 2 ϕ ) W ( Γ2 ) R ( 2 ϕ ) W ( Γ1 ) R ( ϕ ) \qquad ( 6 )$$

$$Γ1 = \frac{2 πΔ nd 1}{λ} \qquad ( 7 )$$

$$Γ2 = \frac{2 πΔ nd 2}{λ} \qquad ( 8 )$$

$$Γ3 = \frac{2 πΔ nd 3}{λ} \qquad ( 9 )$$

Next, the polarization contrast pCR is expressed using the Jones matrix. When expressing the overall Jones matrix of the birefringent plates 310 to 330 by the following Equation (10), the transmitted light, in a case in which the emission light L2 is caused to transmit through an analyzer having a transmission axis perpendicular to the desired polarization direction (the X direction) of the polarized light component, is expressed by the following Equation (11), and the transmitted light intensity I1 is expressed by the following Equation (12). Here, the symbol “*” represents a complex conjugate.

$$W = [ \begin{matrix}{W}_{1} & {W}_{2} \\ {W}_{3} & {W}_{4}\end{matrix} ] \qquad ( 10 )$$

$$[ \begin{matrix}{E}_{x 1} \\ {E}_{y 1}\end{matrix} ] = [ \begin{matrix}0 & 0 \\ 0 & 1\end{matrix} ] [ \begin{matrix}{W}_{1} & {W}_{2} \\ {W}_{3} & {W}_{4}\end{matrix} ] [ \begin{matrix}1 \\ 0\end{matrix} ] = [ \begin{matrix}0 \\ {W}_{3}\end{matrix} ] \qquad ( 11 )$$

$$I 1 = {\vert [ \begin{matrix}0 \\ {W}_{3}\end{matrix} ] \vert}^{2} = {W}_{3} \cdot {W}_{3}^{*} \qquad ( 12 )$$

The transmitted light, in a case in which the emission light L2 is caused to transmit through an analyzer having a transmission axis parallel to the desired polarization direction (the X direction) of the polarized light component, is expressed by the following Equation (13), and the transmitted light intensity 12 is expressed by the following Equation (14).

$$[ \begin{matrix}{E}_{x 2} \\ {E}_{y 2}\end{matrix} ] = [ \begin{matrix}1 & 0 \\ 0 & 0\end{matrix} ] [ \begin{matrix}{W}_{1} & {W}_{2} \\ {W}_{3} & {W}_{4}\end{matrix} ] [ \begin{matrix}1 \\ 0\end{matrix} ] = [ \begin{matrix}{W}_{1} \\ 0\end{matrix} ] \qquad ( 13 )$$

$$I 2 = {\vert [ \begin{matrix}{W}_{1} \\ 0\end{matrix} ] \vert}^{2} = {W}_{1} \cdot {W}_{1}^{*} \qquad ( 14 )$$

The polarization contrast pCR is expressed, on the basis of Equations (6) to (9), (12), and (14), by the following Equations (15) and (16).

$$p C R = \frac{I 2}{I 1} = - \frac{J + 52}{J - 76} \qquad ( 15 )$$

$$J = 9 cos ( \frac{2 πΔ nd 3 + 2 πΔ nd 2 + 2 πΔ nd 1}{λ} ) - 3 cos ( \frac{2 πΔ nd 3 + 2 πΔ nd 2 - 2 πΔ nd 1}{λ} ) + 18 cos ( \frac{2 πΔ nd 3 + 2 πΔ nd 2}{λ} ) + cos ( \frac{2 πΔ nd 3 - 2 πΔ nd 2 + 2 πΔ nd 1}{λ} ) - 3 cos ( \frac{2 πΔ nd 3 - 2 πΔ nd 2 - 2 πΔ nd 1}{λ} ) - 6 cos ( \frac{2 πΔ nd 3 - 2 πΔ nd 2}{λ} ) - 6 cos ( \frac{2 πΔ nd 3 + 2 πΔ nd 1}{λ} ) - 6 cos ( \frac{2 πΔ nd 3 - 2 πΔ nd 1}{λ} ) + 12 cos ( \frac{2 πΔ nd 3}{λ} ) + 18 cos ( \frac{2 πΔ nd 2 + 2 πΔ nd 1}{λ} ) - 6 cos ( \frac{2 πΔ nd 2 - 2 πΔ nd 1}{λ} ) + 36 cos ( \frac{2 πΔ nd 2}{λ} ) + 12 cos ( \frac{2 πΔ nd 1}{λ} ) \qquad ( 16 )$$

Meanwhile, the relationship between the voltage V to be applied to the liquid crystal cells 100 and the residual birefringence Δnd in the liquid crystal cells 100 in the ON state is obtained as follows.

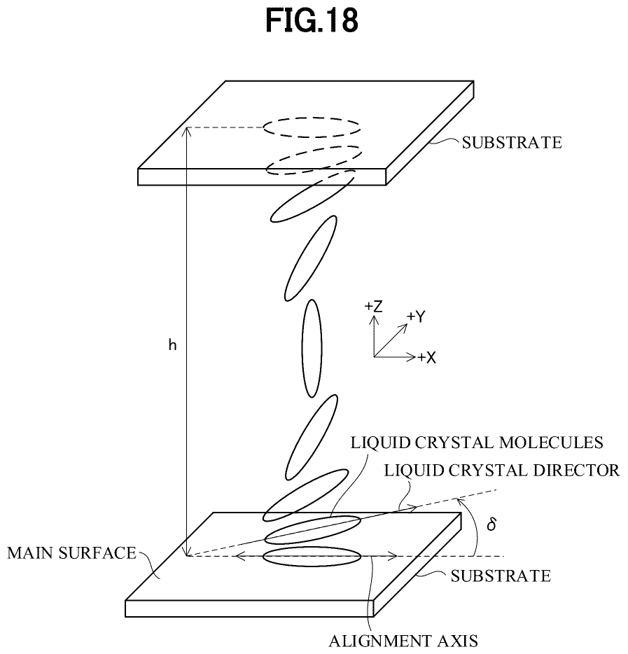

Firstly, as illustrated in FIG. 18, an alignment model is set in which, as the thickness h from the substrate to the main surface increases, the angle δ of the liquid crystal director relative to the main surface of the substrate increases. When no is the ordinary light refractive index of the liquid crystal, ne is the extraordinary light refractive index, neff (x, y, z) is the refractive index in the alignment axis direction of the liquid crystal at a position (x, y, z), M is a number of divisions into which the interior of the thickness h is divided into a plurality of regions in the thickness direction, Ani is the refractive index anisotropy (phase difference) of the divided ith region, Δn (x, y, z) is the refractive index anisotropy (phase difference) at the position (x, y, z), and d is the cell thickness of the liquid crystal cells 100, the birefringence Δnd is expressed by the following Equations (17) to (19).

$${n}_{eff} ( x , y , z ) = \frac{{n}_{o} {n}_{e}}{\sqrt{{n}_{e}^{2} {sin}^{2} δ + {n}_{o}^{2} {cos}^{2} δ}} \qquad ( 17 )$$

$$Δ n ( x , y , z ) = {n}_{eff} ( x , y , z ) - {n}_{o} \qquad ( 18 )$$

$$Δ nd ( x , y ) = {\sum }_{i = 1}^{M} Δ {n}_{i} \frac{h}{M} \qquad ( 19 )$$

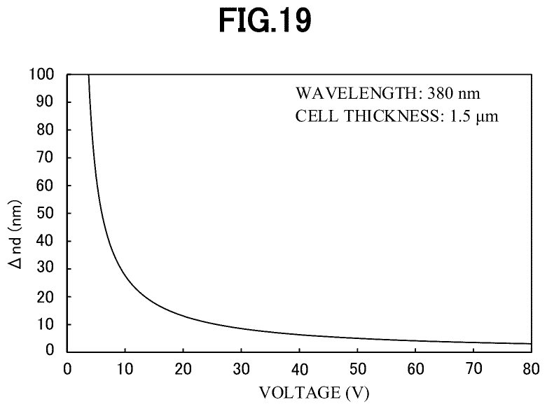

In one example, the relationship between the voltage V to be applied and the angle δ of the liquid crystal director relative to the main surface of the substrate is obtained by a liquid crystal simulator (for example, LCD master, manufactured by Shintech). The relationship, illustrated in FIG. 19, for example, between the voltage V to be applied to the liquid crystal cells 100 and the residual birefringence Δnd in the liquid crystal cells 100 in the ON state is obtained from the obtained relationship between the voltage V to be applied and the angle δ of the liquid crystal director relative to the main surface of the substrate, and Equations (17) to (19).

As illustrated in FIG. 11, the voltages V1 to V3 to be respectively applied to the liquid crystal cells 110 to 130 can be obtained by obtaining, from the relationship between the voltage V to be applied and the residual birefringence Δnd in the liquid crystal cells 100 in the ON state, and Equations (15) and (16), a combination whereby the set polarization contrast pCR is satisfied, and the sum of the voltage V1 to be applied to the liquid crystal cell 110, the voltage V2 to be applied to the liquid crystal cell 120, and the voltage V3 to be applied to the liquid crystal cell 130 is smallest.

As described above, the polarization modulation device 10 applies the voltage V2 that is higher than the voltages V1 and V3 applied to the other liquid crystal cells 110 and 130 to the liquid crystal cell 120 for which the absolute value of the difference between 45° and the average alignment angle θa is smallest. As such, the influence of the residual birefringence of the nematic liquid crystal 106 near the interface can be reduced, and the voltage applied to the entire polarization modulation element 20 can be reduced. That is, the polarization modulation device 10 can emit, at high intensity and with low voltage, a polarized light component having a desired polarization direction. Additionally, in both the ON state and the initial alignment state, the polarization modulation device 10 can emit a polarized light component having a desired polarization direction at high intensity across a wide range of wavelengths.

### Embodiment 2

In Embodiment 1, the angle θ1 of the alignment axis 200A, the angle θ2 of the alignment axis 200B, and the average alignment angle θa of the first liquid crystal cell 110 are 15°; the angle θ1 of the alignment axis 200A, the angle θ2 of the alignment axis 200B, and the average alignment angle θa of the second liquid crystal cell 120 are 45°; and the angle θ1 of the alignment axis 200A, the angle θ2 of the alignment axis 200B, and the average alignment angle θa of the third liquid crystal cell 130 are 75°. However, the angle θ1 of the alignment axis 200A, the angle θ2 of the alignment axis 200B, and the average alignment angle θa are not limited thereto.

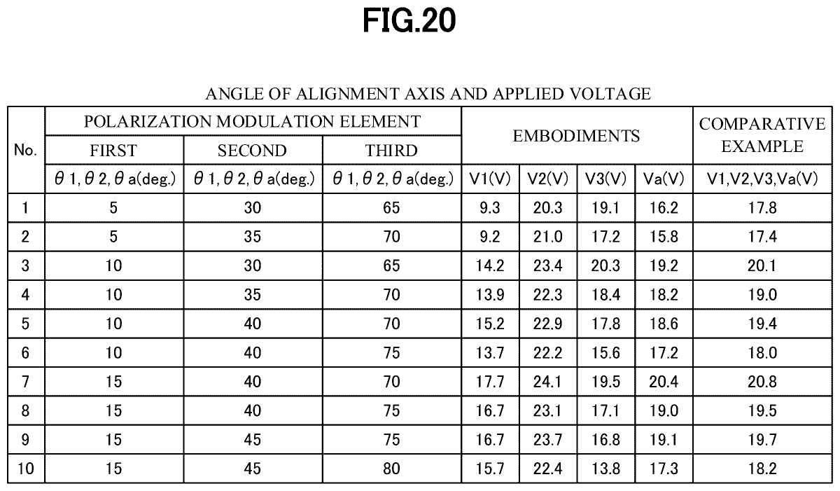

FIG. 20 illustrates an example of the voltages V1 to V3 to be respectively applied to the liquid crystal cells 110 to 130 and the average voltage value Va in order to set the polarization contrast pCR to 20 in a polarization modulation element 20 in which the angle θ1 of the alignment axis 200A, the angle θ2 of the alignment axis 200B, and the average alignment angle θa of the liquid crystal cells 110 to 130 are changed (wavelength λ:380 nm). As in Embodiment 1, the Embodiment fields in FIG. 20 are examples in which the voltage V2 that is higher than the voltages V1 and V3 applied to the liquid crystal cells 110 and 130 is applied to the liquid crystal cell 120 for which the absolute value of the difference between 45° and the average alignment angle θa is the smallest; and the Comparative Example fields are an example in which identical voltages V1 to V3 are applied to the liquid crystal cells 110 to 130. Note that the voltages V1 to V3 of the present embodiment are obtained by the same method as the voltages V1 to V3 of Embodiment 1.

As illustrated in FIG. 20, the average voltage value Va of the present embodiment needed to set the polarization contrast pCR to 20 is less than the average voltage value Va of the Comparative Example needed to set the polarization contrast pCR to 20. That is, in the polarization modulation device 10 of the present embodiment, as with the polarization modulation device 10 of Embodiment 1, the voltage V2 that is higher than the voltages V1 and V3 applied to the liquid crystal cells 110 and 130 is applied to the liquid crystal cell 120 for which the absolute value of the difference between 45° and the average alignment angle θa is smallest. As a result, the influence, on the emission light L2, of the residual birefringence of the nematic liquid crystal 106 near the interface can be reduced, and the voltage applied to the entire polarization modulation element 20 can be reduced.

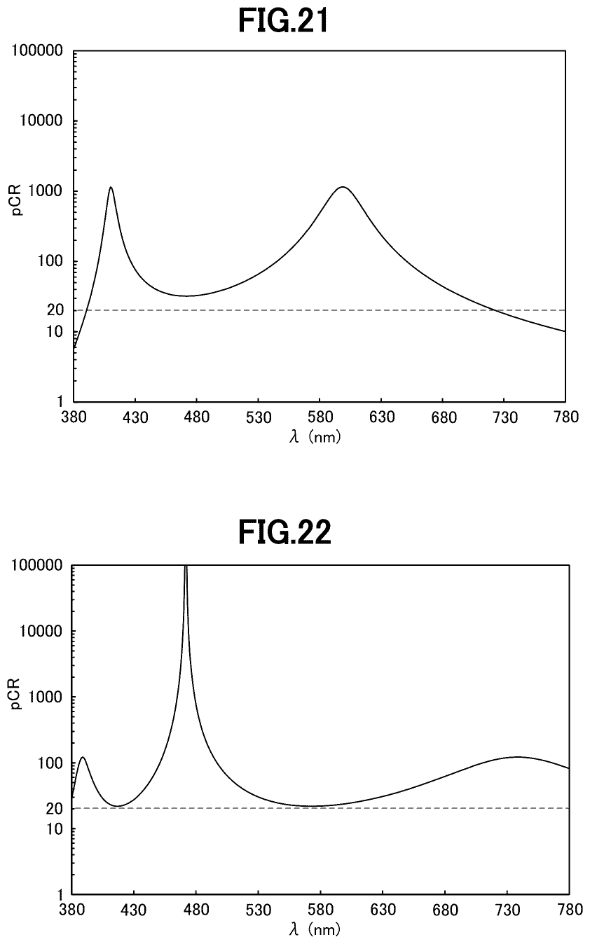

FIG. 21 illustrates the polarization contrast pCR and the wavelength 2 of the linearly polarized light L1 of the polarization modulation element 20 of No. 2 illustrated in FIG. 20 (first liquid crystal cell 110: θa=5°, second liquid crystal cell 120: θa=35°, third liquid crystal cell 130: θa=) 70°, in the initial alignment state. FIG. 22 illustrates the polarization contrast pCR and the wavelength 2 of the linearly polarized light L1 of the polarization modulation element 20 of No. 7 illustrated in FIG. 20 (first liquid crystal cell 110: θa=15°, second liquid crystal cell 120: θa=40°, third liquid crystal cell 130: θa=) 70°, in the initial alignment state. As illustrated in FIGS. 21 and 22, in the initial alignment state, the polarization modulation device 10 (the polarization modulation element 20) of the present embodiment also can emit a polarized light component having a desired polarization direction at high intensity across a wide range of wavelengths.

### Embodiment 3

In Embodiment 1, the polarization modulation element 20 includes three liquid crystal cells 110 to 130. However, it is sufficient that the polarization modulation element 20 includes a plurality of liquid crystal cells 100.

In the present embodiment, a polarization modulation device 10 that includes a polarization modulation element 20 provided with two liquid crystal cells 100, and a controller 30 is described. In the present embodiment as well, in the initial alignment state, the polarization modulation element 20 functions as a ½ wavelength plate for the linearly polarized light L1 and, in the ON state, maintains the polarization direction of the linearly polarized light L1 and emits that light as the emission light L2. Each of the two liquid crystal cells 100 functions as a ½ wavelength plate in the initial alignment state.

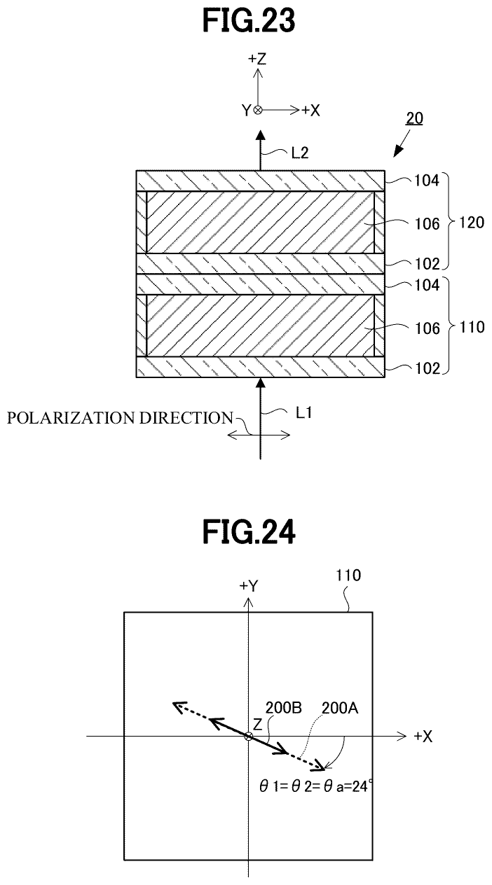

As illustrated in FIG. 23, the polarization modulation element 20 of the present embodiment includes the two liquid crystal cells 110 and 120. As with Embodiment 1, the liquid crystal cell 110 and the liquid crystal cell 120 of the present embodiment are sequentially stacked. The configurations of the liquid crystal cell 110 and the liquid crystal cell 120 of the present embodiment are the same as the configurations of the liquid crystal cells 100 of Embodiment 1, with the exception of the angle θ1 of the alignment axis 200A of the light incident-side substrate 102, the angle θ2 of the alignment axis 200B of the light emitting-side substrate 104, and the average alignment angle θa.

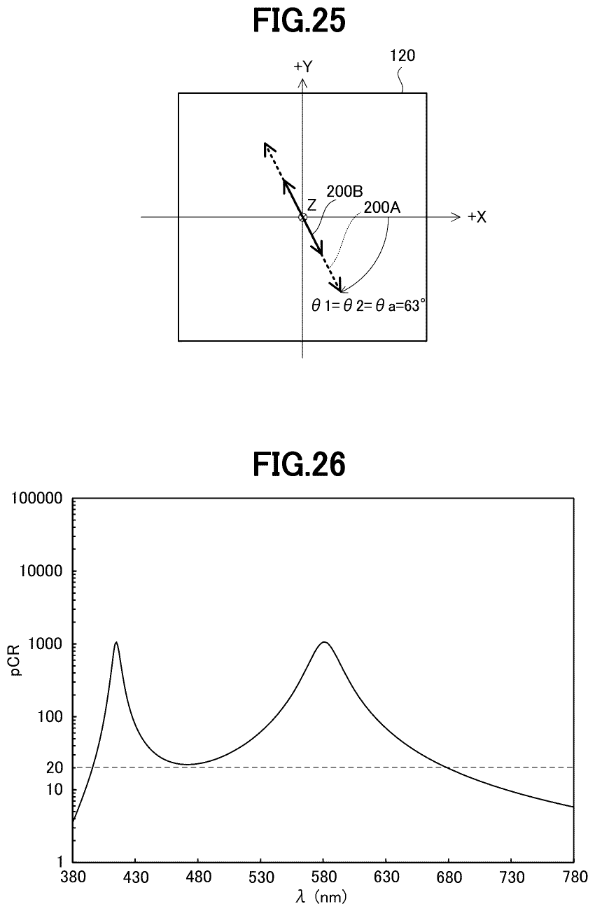

In the first liquid crystal cell 110 of the present embodiment, as illustrated in FIG. 24, the angle θ1 of the alignment axis 200A of the light incident-side substrate 102, the angle θ2 of the alignment axis 200B of the light emitting-side substrate 104, and the average alignment angle θa are 24°. In the second liquid crystal cell 120 of the present embodiment, as illustrated in FIG. 25, the angle θ1 of the alignment axis 200A of the light incident-side substrate 102, the angle θ2 of the alignment axis 200B of the light emitting-side substrate 104, and the average alignment angle θa are 63°.

FIG. 26 illustrates the polarization contrast pCR and the wavelength 2 of the linearly polarized light L1 of the polarization modulation device 10 (the polarization modulation element 20) in the initial alignment state. As illustrated in FIG. 26, the polarization modulation device 10 of the present embodiment also can emit a polarized light component having a desired polarization direction at high intensity across a wide range of wavelengths.

As with the controller 30 of Embodiment 1, when switching the polarization direction of the emission light L2 from the Y direction to the X direction, the controller 30 of the present embodiment applies a voltage that is higher than the voltage applied to the other liquid crystal cell 100 to the liquid crystal cell 100 for which the absolute value of the difference between 45° and the average alignment angle θa is smallest. The controller 30 applies the voltage V2 that is higher than the voltage V1 applied to the liquid the liquid crystal cell 110 to the liquid crystal cell 120 for which the absolute value of the difference between 45° and the average alignment angle θa is smallest.

Specifically, the controller 30 can set the polarization contrast pCR to 20 by applying voltage of 15.22V (V1=15.22V) to the liquid crystal cell 110, and applying voltage of 15.69V (V2=15.69V) to the liquid crystal cell 120. In this case, the average voltage value Va is 15.455V (Va=15.455V). Meanwhile, in a case in which identical voltages are applied to the liquid crystal cell 110 and the liquid crystal cell 120, voltage of 15.46V (average voltage value Va=15.46) must be applied to each of the liquid crystal cell 110 and the liquid crystal cell 120 in order to set the polarization contrast pCR to 20. Note that, in the present embodiment as well, the voltages V1 and V2 to be applied to the liquid crystal cells 110 and 120 are obtained by the same method as in Embodiment 1. Additionally, the wavelength 2 of the linearly polarized light L1 is 380 nm.

As described above, the polarization modulation device 10 of the present embodiment applies the voltage V2 that is higher than the voltage V1 applied to the liquid crystal cell 110 to the liquid crystal cell 120 for which the absolute value of the difference between 45° and the average alignment angle θa is smallest. As such, the polarization modulation device 10 can reduce the influence, on the emission light L2, of the residual birefringence of the nematic liquid crystal 106 near the interface, and can emit, at high intensity and with low voltage, a polarized light component having a desired polarization direction.

### Embodiment 4

In Embodiment 3, the angle θ1 of the alignment axis 200A, the angle θ2 of the alignment axis 200B, and the average alignment angle θa of the first liquid crystal cell 110 is 24°; and the angle θ1 of the alignment axis 200A, the angle θ2 of the alignment axis 200B, and the average alignment angle θa of the second liquid crystal cell 120 is 63°. However, the angle θ1 of the alignment axis 200A, the angle θ2 of the alignment axis 200B, and the average alignment angle θa are not limited thereto.

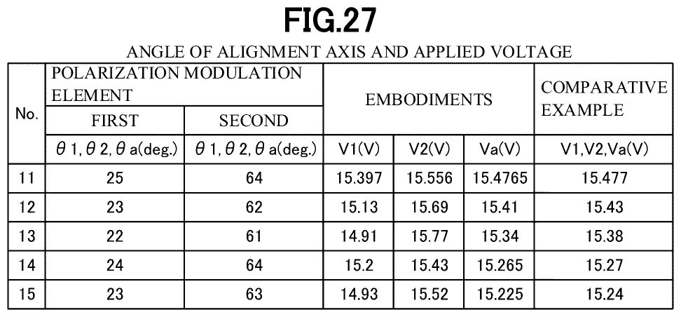

FIG. 27 illustrates an example of the voltages V1 to V2 to be respectively applied to the liquid crystal cells 110 and 120, and the average voltage value Va in order to set the polarization contrast pCR to 20 in a polarization modulation element 20 in which the angle θ1 of the alignment axis 200A, the angle θ2 of the alignment axis 200B, and the average alignment angle θa of the liquid crystal cells 110 and 120 are changed (wavelength λ:380 nm). As in Embodiment 3, the Embodiment fields in FIG. 27 are examples in which the voltage V2 that is higher than the voltage V1 applied to the liquid crystal cell 110 is applied to the liquid crystal cell 120 for which the absolute value of the difference between 45° and the average alignment angle θa is the smallest; and the Comparative Example fields are an example in which identical voltages V1 and V2 are applied to the liquid crystal cells 110 and 120. The voltages V1 and V2 to be applied to the liquid crystal cells 110 and 120 of the present embodiment are obtained by the same method as in Embodiment 1.

As illustrated in FIG. 27, the average voltage value Va of the present embodiment needed to set the polarization contrast pCR to 20 is less than the average voltage value Va of the Comparative Example needed to set the polarization contrast pCR to 20. That is, in the present embodiment as well, the polarization modulation device 10 applies the voltage V2 that is higher than the voltage V1 applied to the liquid crystal cell 110 to the liquid crystal cell 120 for which the absolute value of the difference between 45° and the average alignment angle θa is smallest. As a result, the influence, on the emission light L2, of the residual birefringence of the nematic liquid crystal 106 near the interface can be reduced, and the voltage applied to the entire polarization modulation element 20 can be reduced.

### Embodiment 5

In Embodiment 1, the polarization modulation element 20 includes three liquid crystal cells 110 to 130. Additionally, the polarization modulation element 20 of Embodiment 1 includes one liquid crystal cell 100 (the liquid crystal cell 120) for which the absolute value of the difference between 45° and the average alignment angle θa is smallest. However, it is sufficient that the polarization modulation element 20 includes a plurality of liquid crystal cells 100. A configuration is possible in which the polarization modulation element 20 includes a plurality of liquid crystal cells 100 for which the absolute value of the difference between 45° and the average alignment angle θa is smallest, and the controller 30 applies voltage that is higher than the voltage applied to the other liquid crystal cells 100 to the plurality of liquid crystal cells 100 for which the absolute value of the difference between 45° and the average alignment angle θa is smallest. In the present embodiment, a polarization modulation device 10 that includes a polarization modulation element 20 provided with four liquid crystal cells 100, and a controller 30 is described.

In the present embodiment as well, in the initial alignment state, the polarization modulation element 20 functions as a ½ wavelength plate for the linearly polarized light L1 and, in the ON state, maintains the polarization direction of the linearly polarized light L1 and emits that light as the emission light L2. Each of the four liquid crystal cells 100 functions as a ½ wavelength plate in the initial alignment state.

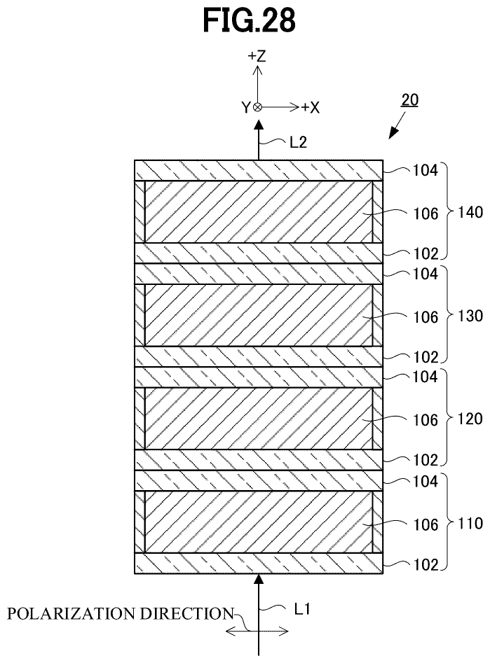

As illustrated in FIG. 28, the polarization modulation element 20 of the present embodiment includes four liquid crystal cells 110 to 140. As with Embodiment 1, the liquid crystal cells 110 to 140 of the present embodiment are sequentially stacked. The configurations of the liquid crystal cells 110 to 140 of the present embodiment are the same as the configurations of the liquid crystal cells 100 of Embodiment 1, with the exception of the angle θ1 of the alignment axis 200A of the light incident-side substrate 102, the angle θ2 of the alignment axis 200B of the light emitting-side substrate 104, and the average alignment angle θa.

In the first liquid crystal cell 110 of the present embodiment, the angle θ1 of the alignment axis 200A of the light incident-side substrate 102, the angle θ2 of the alignment axis 200B of the light emitting-side substrate 104, and the average alignment angle θa are 11.25°. In the second liquid crystal cell 120 of the present embodiment, the angle θ1 of the alignment axis 200A of the light incident-side substrate 102, the angle θ2 of the alignment axis 200B of the light emitting-side substrate 104, and the average alignment angle θa are 33.75°. In the third liquid crystal cell 130 of the present embodiment, the angle θ1 of the alignment axis 200A of the light incident-side substrate 102, the angle θ2 of the alignment axis 200B of the light emitting-side substrate 104, and the average alignment angle θa are 56.25°. In the fourth liquid crystal cell 140 of the present embodiment, the angle θ1 of the alignment axis 200A of the light incident-side substrate 102, the angle θ2 of the alignment axis 200B of the light emitting-side substrate 104, and the average alignment angle θa are 78.75°.

In the present embodiment, the absolute value of the difference between 45° and the average alignment angle θa of the liquid crystal cell 120, and the absolute value of the difference between 45° and the average alignment angle θa of the liquid crystal cell 130 are equal (absolute value: 11.25). The liquid crystal cell 120 and the liquid crystal cell 130 correspond to the liquid crystal cells 100 for which the absolute value of the difference between 45° and the average alignment angle θa is smallest. Here, the phrase “the absolute values of the difference between 45° and the average alignment angle θa” includes cases in which the absolute values of the difference between 45° and the average alignment angle θa perfectly match, and also cases in which the absolute values of the difference between 45° and the average alignment angle θa substantially match. The cases in which the absolute values substantially match are, for example, cases in which a difference between the absolute values of the difference between 45° and the average alignment angle θa is within manufacturing tolerances.

As with the controller 30 of Embodiment 1, when switching the polarization direction of the emission light L2 from the Y direction to the X direction, the controller 30 of the present embodiment applies a voltage that is higher than the voltage applied to the other liquid crystal cells 100 to the liquid crystal cells 100 for which the absolute value of the difference between 45° and the average alignment angle θa is smallest. In the present embodiment, the absolute values of the difference between 45° and the average alignment angle θa of the liquid crystal cell 120 and the liquid crystal cell 130 are smallest and, as such, the controller 30 applies voltages V2 and V3 that are higher than the voltage V1 applied to the liquid crystal cell 110 and a voltage V4 applied to the liquid crystal cell 140 to the liquid crystal cell 120 and the liquid crystal cell 130. The voltage V2 applied to the liquid crystal cell 120 and the voltage V3 applied to the liquid crystal cell 130 may be equal, or one may be higher than the other.

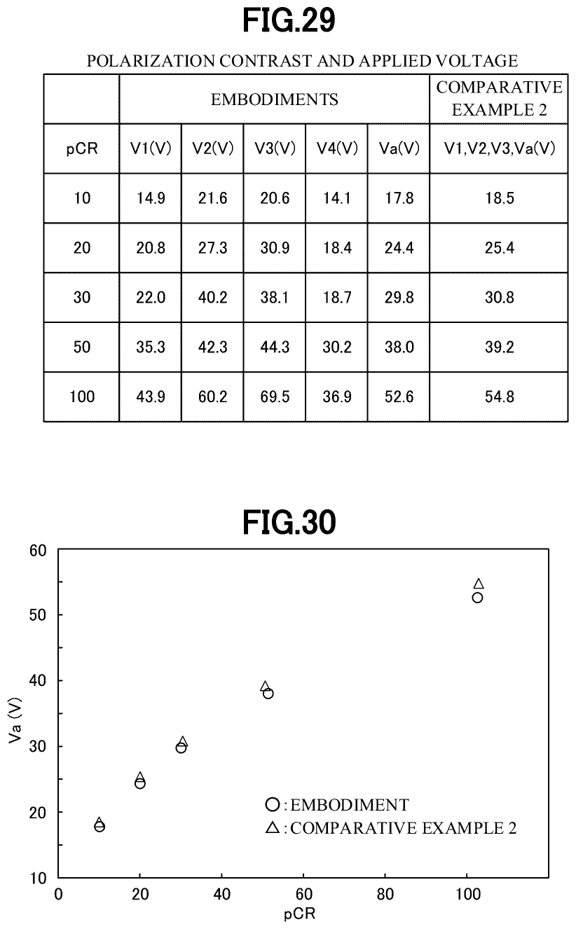

FIG. 29 illustrates an example of the polarization contrast pCR and the voltages V1 to V4 applied respectively to the liquid crystal cells 110 to 140 in a case in which the voltages V2 and V3 that are higher than the voltages V1 and V4 applied to the liquid crystal cell 110 and the liquid crystal cell 140 are applied to the liquid crystal cells 120 and 130 for which the absolute values of the difference between 45° and the average alignment angle θa are the smallest; and the polarization contrast pCR and the voltages applied in Comparative Example 2 (wavelength λ: 380 nm). FIG. 30 illustrates the relationship between the polarization contrast pCR, and the average voltage value Va illustrated in FIG. 29 and the average voltage value Va of Comparative Example 2. Comparative Example 2 is an example in which identical voltages V1 to V4 are respectively applied to the liquid crystal cells 110 to 140. The voltages V1 to V4 to be applied to the liquid crystal cells 110 to 140 of the present embodiment are obtained by the same method as in Embodiment 1.

As illustrated in FIG. 30, the average voltage value Va of the present embodiment is less than the average voltage value Va of Comparative Example 2 (for example, when the polarization contrast pCR is 20, the average voltage value Va of the present embodiment is 24.35V and the average voltage value Va of Comparative Example 2 is 25.40V). That is, the polarization modulation device 10 of the present embodiment can emit, at high intensity and with lower voltage, a polarized light component having a desired polarization direction.

As described above, the polarization modulation device 10 of the present embodiment applies the voltages V2 and V3 that are higher than the voltages V1 and V4 applied to the liquid crystal cells 110 and 140 to the liquid crystal cells 120 and 130 for which the absolute values of the difference between 45° and the average alignment angle θa are smallest. As such, the polarization modulation device 10 can reduce the influence, on the emission light L2, of the residual birefringence of the nematic liquid crystal 106 near the interface, and can emit, at high intensity and with low voltage, a polarized light component having a desired polarization direction.

### Embodiment 6

In Embodiments 1 to 5, the nematic liquid crystal 106 of the liquid crystal cells 100 is anti-parallel aligned. However, a configuration is possible in which the nematic liquid crystal 106 of the liquid crystal cells 100 is twist-aligned. As with the polarization modulation device 10 of Embodiments 1 to 5, the polarization modulation device 10 of the present embodiment includes a polarization modulation element 20 and a controller 30. As with the polarization modulation element 20 of Embodiment 1, in the initial alignment state, the polarization modulation element 20 of the present embodiment functions as a ½ wavelength plate for the linearly polarized light L1 incident on the liquid crystal cell 110. Additionally, in the ON state, the polarization modulation element 20 of the present embodiment maintains the polarization direction of the linearly polarized light L1 and emits this light as emission light L2. The controller 30 of the present embodiment applies voltage to the liquid crystal cells 110 to 140 to switch the polarization direction of the emission light L2 emitted from the polarization modulation element 20.

As with the polarization modulation element 20 of Embodiment 5, the polarization modulation element 20 of the present embodiment includes four liquid crystal cells 110 to 140. As with the liquid crystal cells 100 of Embodiment 1, the liquid crystal cells 110 to 140 of the present embodiment are sequentially stacked with the light incident-side substrate 102 of one of the liquid crystal cells 100 and the light emitting-side substrate 104 of another of the liquid crystal cells 100 opposing each other. The configurations of the liquid crystal cells 110 to 140 of the present embodiment are the same as the configurations of the liquid crystal cells 100 of Embodiment 1, with the exception of the alignment of the nematic liquid crystal 106, the angle θ1 of the alignment axis 200A of the light incident-side substrate 102, the angle θ2 of the alignment axis 200B of the light emitting-side substrate 104, and the average alignment angle θa. Note that each of the liquid crystal cells 110 to 140 of the present embodiment does not function as a ½ wavelength plate.

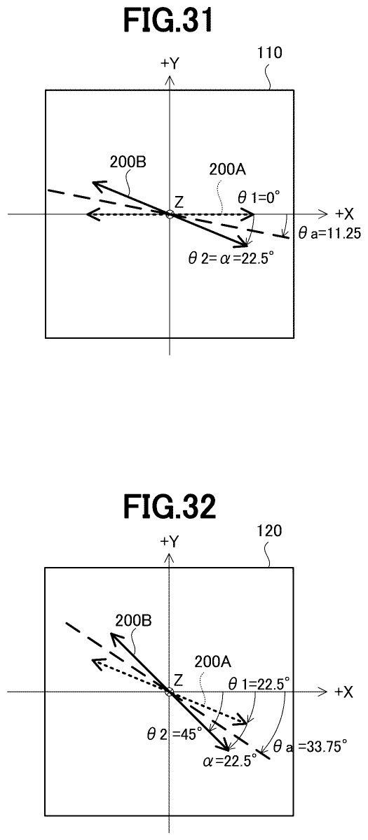

In the initial alignment state of the liquid crystal cells 110 to 114, the nematic liquid crystal 106 is aligned twisted clockwise when viewed from above from the +Z side. As illustrated in FIGS. 31 to 34, a twist angle α of the liquid crystal cells 110 to 140 (that is, the twist angle of the nematic liquid crystal 106) is 22.5°. The sum of the twist angles α of the various liquid crystal cells 110 to 140 is 90°. In the present embodiment, as described later, in adjacent liquid crystal cells 100, the angle θ2 of the alignment axis 200B of the light emitting-side substrate 104 of one of the liquid crystal cells 100 and the angle θ1 of the alignment axis 200A of the light incident-side substrate 102 of another of the liquid crystal cells 100 match. The average alignment angles θa of the liquid crystal cells 110 to 140 differ from each other.

Specifically, as illustrated in FIG. 31, in the first liquid crystal cell 110, the angle θ1 of the alignment axis 200A of the light incident-side substrate 102 is 0°, and the angle θ2 of the alignment axis 200B of the light emitting-side substrate 104 is 22.5°. The average alignment angle θa of the liquid crystal cell 110 is 11.25°.

As illustrated in FIG. 32, in the second liquid crystal cell 120, the angle θ1 of the alignment axis 200A of the light incident-side substrate 102 is 22.5°, and matches the angle θ2 of the alignment axis 200B of the light emitting-side substrate 104 of the liquid crystal cell 110. The angle θ2 of the alignment axis 200B of the light emitting-side substrate 104 is 45°. The average alignment angle θa of the liquid crystal cell 120 is 33.75°.

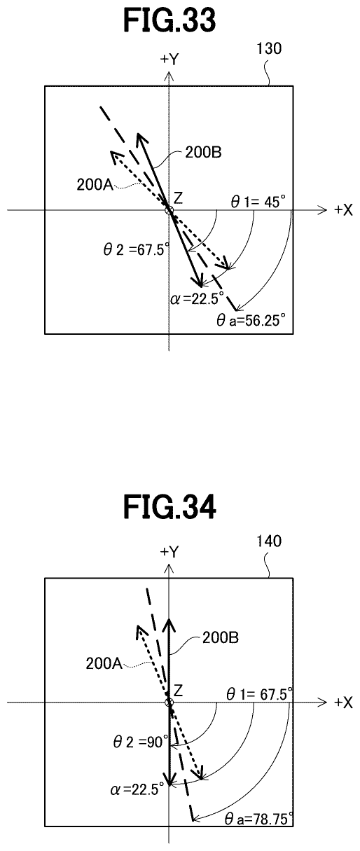

As illustrated in FIG. 33, in the third liquid crystal cell 130, the angle θ1 of the alignment axis 200A of the light incident-side substrate 102 is 45°, and matches the angle θ2 of the alignment axis 200B of the light emitting-side substrate 104 of the liquid crystal cell 120. The angle θ2 of the alignment axis 200B of the light emitting-side substrate 104 is 67.5°. The average alignment angle θa of the liquid crystal cell 130 is 56.25°.

As illustrated in FIG. 34, in the fourth liquid crystal cell 140, the angle θ1 of the alignment axis 200A of the light incident-side substrate 102 is 67.5°, and matches the angle θ2 of the alignment axis 200B of the light emitting-side substrate 104 of the liquid crystal cell 130. The angle θ2 of the alignment axis 200B of the light emitting-side substrate 104 is 90°. The average alignment angle θa of the liquid crystal cell 140 is 78.75°.

In the present embodiment, the absolute value of the difference between 45° and the average alignment angle θa of the liquid crystal cell 120, and the absolute value of the difference between 45° and the average alignment angle θa of the liquid crystal cell 130 are equal (absolute value: 11.25). The liquid crystal cell 120 and the liquid crystal cell 130 correspond to the liquid crystal cells 100 for which the absolute value of the difference between 45° and the average alignment angle θa is smallest (absolute value: 11.25).

As with the controller 30 of Embodiment 5, the controller 30 of the present embodiment applies a voltage that is higher than the voltage applied to the other liquid crystal cells 100 to the liquid crystal cells 100 for which the absolute value of the difference between 45° and the average alignment angle θa is smallest. In the present embodiment, the absolute values of the difference between 45° and the average alignment angle θa of the liquid crystal cell 120 and the liquid crystal cell 130 are smallest and, as such, the controller 30 applies voltages V2 and V3 that are higher than the voltage V1 applied to the liquid crystal cell 110 and a voltage V4 applied to the liquid crystal cell 140 to the liquid crystal cell 120 and the liquid crystal cell 130. The voltage V2 applied to the liquid crystal cell 120 and the voltage V3 applied to the liquid crystal cell 130 may be equal, or one may be higher than the other.

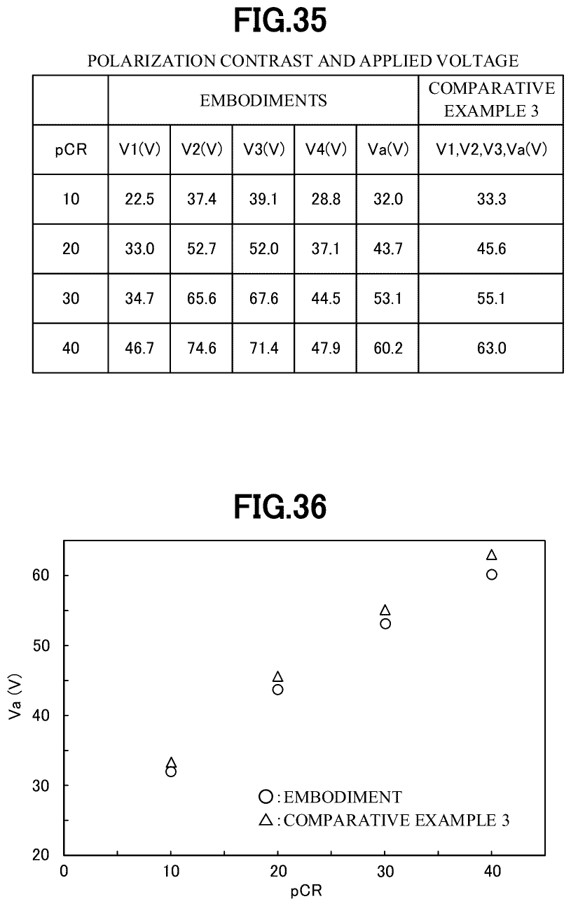

FIG. 35 illustrates an example of the polarization contrast pCR and the voltages V1 to V4 applied respectively to the liquid crystal cells 110 to 140 in a case in which the voltages V2 and V3 that are higher than the voltages V1 and V4 applied to the liquid crystal cell 110 and the liquid crystal cell 140 are applied to the liquid crystal cells 120 and 130 for which the absolute values of the difference between 45° and the average alignment angle θa are the smallest; and the polarization contrast pCR and the voltages applied in Comparative Example 3 (wavelength λ: 380 nm). FIG. 36 illustrates the relationship between the polarization contrast pCR, and the average voltage value Va illustrated in FIG. 29 and the average voltage value Va of Comparative Example 3. Comparative Example 3 is an example in which identical voltages V1 to V4 are respectively applied to the liquid crystal cells 110 to 140. The voltages V1 to V4 to be applied to the liquid crystal cells 110 to 140 of the present embodiment are obtained by the same method as in Embodiment 1.

As illustrated in FIG. 36, the average voltage value Va of the present embodiment is less than the average voltage value Va of Comparative Example 3 (for example, when the polarization contrast pCR is 20, the average voltage value Va of the present embodiment is 43.7V and the average voltage value Va of Comparative Example 3 is 45.6V). That is, the polarization modulation device 10 of the present embodiment also can emit, at high intensity and with lower voltage, a polarized light component having a desired polarization direction.

As described above, even in a case in which the nematic liquid crystal 106 is twist-aligned, the polarization modulation device 10 of the present embodiment applies the voltages V2 and V3 that are higher than the voltages V1 and V4 applied to the liquid crystal cells 110 and 140 to the liquid crystal cells 120 and 130 for which the absolute values of the difference between 45° and the average alignment angle θa are smallest. As such, the polarization modulation device 10 can reduce the influence, on the emission light L2, of the residual birefringence of the nematic liquid crystal 106 near the interface, and can emit, at high intensity and with low voltage, a polarized light component having a desired polarization direction.

### Modified Examples

Embodiments have been described, but various modifications can be made to the present disclosure without departing from the spirit and scope of the present disclosure.

In Embodiments 1 to 5, the nematic liquid crystal 106 of the liquid crystal cells 100 is anti-parallel aligned. However, a configuration is possible in which the nematic liquid crystal 106 of the liquid crystal cells 100 is parallel-aligned.

In a case in which the average alignment angle θa of the angle θ1 and the angle θ2 of the liquid crystal cell 110 is defined as 011, the average alignment angle θa of the angle θ1 and the angle θ2 of the liquid crystal cell 120 is defined as 012, and the average alignment angle θa of the angle θ1 and the angle θ2 of the liquid crystal cell 130 is defined as 013, the angle θ1 of the alignment axis 200A, the angle θ2 of the alignment axis 200B, and the average alignment angle θa of the liquid crystal cells 110 to 130 in Embodiment 2 (FIG. 20) can be expressed as follows: (a) When 011 is 5° (011=) 5°, 012=011+25°, or 012=011+30° and 013=012+35°. (b) When 011 is 10° or 15° (011=10° or 011=) 15°, 012=011+25° or 012=011+30°, and 013=012+30° or 013=012+35°.

In Embodiment 6, the twist angle α of the nematic liquid crystal 106 is 22.5°. However, in a case in which the nematic liquid crystal 106 of the liquid crystal cells 100 forming the polarization modulation element 20 are twist-aligned, it is sufficient that the twist direction and the twist angle α of the nematic liquid crystal 106 of each of the liquid crystal cells 100 are the same and, additionally, it is sufficient that the sum of the twist angles α of each of the liquid crystal cells 100 is 90°. Furthermore, it is sufficient that a thickness d of the nematic liquid crystal 106 is adjusted to a thickness whereby the polarization modulation element 20 imparts a phase difference of ½ wavelength to the linearly polarized light L1 in the initial alignment state.

In Embodiment 6, the polarization modulation element 20 is not limited to a phase difference of ½ wavelength, and may impart a phase difference that is an odd multiple of ½ wavelength (2xn-1 times, where n is a natural number).

The plurality of liquid crystal cells 100 forming the polarization modulation element 20 includes at least one liquid crystal cell 100 for which the absolute value of the difference between 45° and the average alignment angle θa differs from the absolute value of the difference between 45° and the average alignment angle θa of another of the liquid crystal cells 100. For example, a configuration is possible in which, as in Embodiment 1, in a case in which the polarization modulation element 20 is formed from three liquid crystal cells 100, the absolute values of the difference between 45° and the average alignment angle θa of two of the liquid crystal cells 100 are equal, and the absolute value of the difference between 45° and the average alignment angle θa of the other liquid crystal cell 100 differs from the absolute values of the difference between 45° and the average alignment angle θa of the two liquid crystal cells 100. Additionally, a configuration is possible in which, as in Embodiments 4 and 6, in a case in which the polarization modulation element 20 is formed from four liquid crystal cells 100, the absolute values of the difference between 45° and the average alignment angle θa of the four liquid crystal cells 100 differ from each other.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A polarization modulation device, comprising:
a polarization modulation element including a plurality of liquid crystal cells, each of which includes a light incident-side substrate, a light emitting-side substrate opposing the light incident-side substrate, and a liquid crystal layer sandwiched between the light incident-side substrate and the light emitting-side substrate, linearly polarized light entering the light incident-side substrate of a first liquid crystal cell among the plurality of liquid crystal cells; and
a controller that applies voltage to each of the plurality of liquid crystal cells to switch a polarization direction of emission light emitted from the polarization modulation element, wherein
the plurality of liquid crystal cells are sequentially stacked with the light incident-side substrate of one of the liquid crystal cells opposing the light emitting-side substrate of another of the liquid crystal cells, and
in a case in which each of an angle of an alignment axis of the light incident-side substrate and an angle of an alignment axis of the light emitting-side substrate is set to an angle relative to a polarization direction of the linearly polarized light, and an average value of the angle of the alignment axis of the light incident-side substrate and the angle of the alignment axis of the light emitting-side substrate in each of the plurality of liquid crystal cells is defined as an average alignment angle,
the average alignment angle of each of the plurality of liquid crystal cells differs from each other,
the plurality of liquid crystal cells includes at least one liquid crystal cell for which an absolute value of a difference between 45° and the average alignment angle differs from the absolute value of another of the liquid crystal cells, and
the controller applies a voltage that is higher than a voltage applied to the other liquid crystal cells to the liquid crystal cell for which the absolute value is smallest.

2. The polarization modulation device according to claim 1, wherein
the angle of the alignment axis of the light incident-side substrate and the angle of the alignment axis of the light emitting-side substrate of each of the plurality of liquid crystal cells are equal, and
in a state in which the voltage is not applied, each of the plurality of liquid crystal cells imparts a phase difference of ½ wavelength to light having a predetermined wavelength.

3. The polarization modulation device according to claim 1, wherein
in a state in which the voltage is not applied, the polarization modulation element imparts a phase difference of an odd multiple of ½ wavelength to the linearly polarized light having a predetermined wavelength,
the plurality of liquid crystal cells are liquid crystal cells in which the liquid crystal layer is twist-aligned,
a twist direction and a twist angle of the liquid crystal layer of each of the plurality of liquid crystal cells are the same,
a sum of the twist angle of each of the plurality of liquid crystal cells is 90°, and
in adjacent liquid crystal cells of the liquid crystal cells, the angle of the alignment axis of the light emitting-side substrate of one of the liquid crystal cells and the angle of the alignment axis of the light incident-side substrate of another of the liquid crystal cells match.
